(19) United States
(12) Patent Application Publication
(10) Pub. No.: US 2015/0341555 A1
(43) Pub. Date: Nov. 26, 2015

(54) PANORAMIC CAMERA

(71) Applicant: Tamaggo Holding SA, Geneva (CH)

(72) Inventors: Jean-Claude ARTONNE, Montreal (CA); Stephane LEPAGE, Montreal (CA)

(73) Assignee: Tamaggo Holding SA, Geneva (CH)

(21) Appl. No.: 14/759,451

(22) PCT Filed: Jan. 7, 2013
(86) PCT No.: PCT/CA2013/050009

§ 371 Date: Jul. 7, 2015

(51) Int. Cl. H04N 5/232; G06F 3/041; H04N 5/225

(52) U.S. Cl. CPC H04N 5/23238; H04N 5/2252; H04N 5/23293; G06F 3/041

(57) ABSTRACT

A panoramic camera having an ovoid-shaped housing with top and bottom ends. The camera has a lens near the top end of the housing, a display screen at the bottom end of the housing and an image sensor unit within the housing for capturing images. The camera also has a switch on the housing, where this switch is activatable by an operator of the camera for causing the camera to take a photograph or video. The panoramic camera is configured to be held in one hand by the camera operator when taking a photograph, with the switch being activatable by the same hand.

### TECHNICAL FIELD

The present invention relates generally to the field of digital film and video photography. More particularly, the present invention relates to a hand-held digital camera device that captures a 360-degree panoramic image.

### BACKGROUND

A conventional hand-held digital camera provides a relatively small viewing angle and can only capture images in the direction in which the camera is aimed. Accordingly, each captured image provides a view of only what the camera operator chooses to focus on. Although some cameras use a specialized wide-angle lens to capture a wider panoramic image, such panoramic cameras still have a limited field of view.

Camera systems exist that can capture light from all directions, such that a full 360-degree panoramic image can be created. A full 360-degree panoramic image allows a viewer to choose what he would like to look at within the image, offering multiple different viewing directions and fields of view within the same image. However, these systems and the methods that are known for creating 360-degree panoramic images have several limitations, including mechanical complexity and labor-intensive, time consuming processing.

For instance, a particular method for creating 360-degree panoramic images involves combining a series of individual photographs taken in different directions into a single panoramic image. More specifically, software tools exist for receiving as input a sequence of digitized, overlapping still photographs, taken by a camera at constant degree intervals (e.g. 30 degree intervals) as the camera is turned on a tripod around a vertical axis (possibly rotated automatically by a complex actuator mechanism). The overlapping photographs are merged together by the software tools into one long panoramic strip. Unfortunately, this process is very time-consuming, requiring human intervention, and is prone to temporal artifacts since the photographs being merged together were actually captured at different times. The time change during the series of photographs makes it difficult to create panoramic images in changing scenes. Furthermore, it is difficult to extend this type of process from a single still panoramic image into a continuous frame or a motion picture (i.e. video) panoramic image capture.

In another example, some panoramic camera systems operate by spinning a lens and film to capture a panoramic view in a single sweeping motion. This type of system is mechanically complex and not practical for use as a hand-held camera.

Panoramic camera devices that instantaneously capture a 360 degree panoramic image also exist, for example the devices disclosed in U.S. Pat. No. 6,459,451 and U.S. Pat. No. 7,742,070. However, there remains much room for improvement, with regard to the size, housing, practicality, ease of use and transportation of the camera.

There thus exists a need in the industry to provide an improved panoramic camera.

### SUMMARY

In accordance with a broad aspect, the present invention provides a panoramic camera comprising an ovoid-shaped housing having a top end and a bottom end. The camera includes a lens disposed proximate to the top end of the housing, a display screen disposed at the bottom of the housing and an image sensor unit within the housing, the image sensor unit operative to capture images. A switch is provided on the housing, the switch activatable by a camera operator for causing the camera to take a photograph or video.

In accordance with another broad aspect, the present invention provides a panoramic camera comprising an ovoid-shaped housing having a top end and a bottom end; a lens disposed proximate to the top end of the housing; a display screen disposed at the bottom of the housing; an image sensor unit within the housing operative to capture images; and a switch on the housing, the switch activatable by a camera operator for causing the camera to take a photograph or video. The camera also includes a stand at the bottom end of the housing, the stand movable between a closed position and an open position.

In accordance with yet another broad aspect, the present invention provides a panoramic camera comprising an ovoid-shaped housing having a top end and a bottom end; a lens disposed proximate to the top end of the housing; a display screen disposed at the bottom of the housing; an image sensor unit within the housing operative to capture images; and a switch on the housing, the switch activatable by a camera operator for causing the camera to take a photograph or video. The camera also includes a visual indicator on the housing for guiding the camera operator during the taking of a photograph or video.

### BRIEF DESCRIPTION OF THE DRAWINGS

The invention will be better understood by way of the following detailed description of embodiments of the invention with reference to the appended drawings, in which:

FIG. 1 is a front perspective view of a panoramic camera, in accordance with an embodiment of the present invention.

FIG. 2 is a side view of the panoramic camera of FIG. 1;

FIG. 3 is a front view of the panoramic camera of FIG. 1;

FIG. 4 is a rear view of the panoramic camera of FIG. 1;

FIG. 5 illustrates how the panoramic camera of FIG. 1 is held and used by a camera operator;

FIG. 6 is a schematic illustrating a cross-sectional view of the internal components of the panoramic camera taken along the optical axis of the camera, according to a non-limiting example of implementation of the present invention;

FIG. 7 is a schematic illustrating an exploded view of the components of the panoramic camera, according to a non-limiting example of implementation of the present invention;

FIG. 8 is a schematic illustrating the top housing assembly of the panoramic camera, according to a non-limiting example of implementation of the present invention; and

FIG. 9 is a schematic illustrating the rear housing assembly of the panoramic camera, according to a non-limiting example of implementation of the present invention.

### DETAILED DESCRIPTION

The present invention is directed to a novel, hand-held panoramic camera for instantaneously capturing full 360-degree panoramic images.

Note that, although the panoramic camera will often be discussed herein in the context of taking panoramic pictures or photographs, the novel panoramic camera may also be used to take panoramic videos.

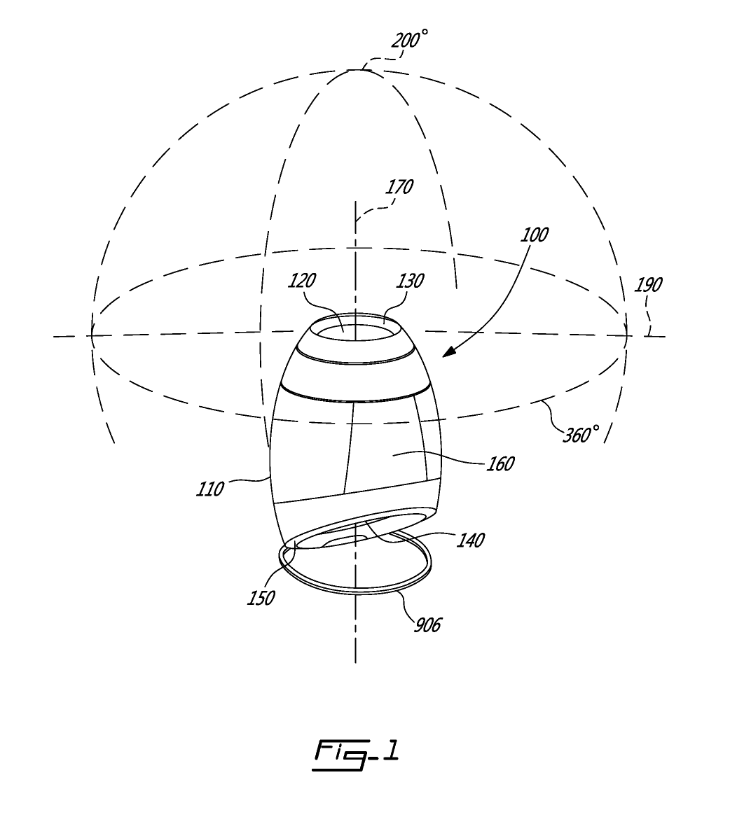

FIG. 1 illustrates the panoramic camera, according to a broad embodiment of the present invention. The panoramic camera 100 has an ovoid-shaped housing 110, with a lens 120 at a top end 130 of the housing 110 and a display screen 140 at a bottom end 150 of the housing 110. An image sensor unit (not shown in FIG. 1) within the housing 110 is operative to capture images, while a switch 160 on the housing 110 is activatable by a camera operator to cause the camera 100 to take a photograph or video.

As shown in FIG. 5, the housing 110 is sized and shaped such that the camera can be comfortably and easily held in one hand by an operator of the camera, the switch 160 activatable by the same hand. In a specific, non-limiting example of implementation, the housing 110 is about 92 mm in length (between top and bottom ends) and has a maximum cross-sectional diameter (or thickness) of about 56 mm, the camera 100 itself weighing only about 7 ounces (200 g). However, various other lengths, diameters and weights are possible without departing from the scope of the present invention.

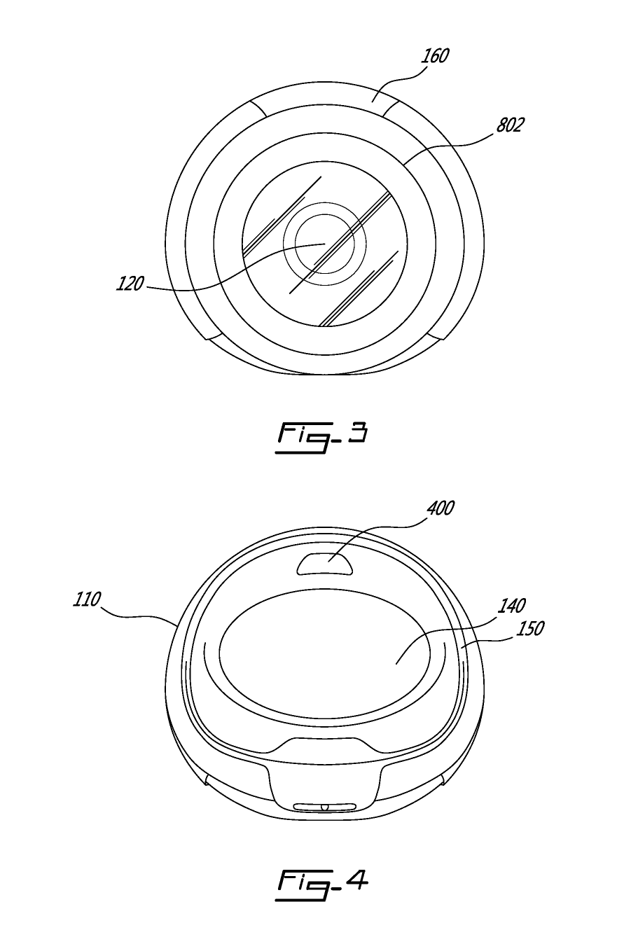

As seen in FIGS. 1, 2 and 3, the housing 110 is shaped substantially like an egg, with a distinct tapering at its top end 130. Advantageously, the small size and ovoid-like shape of the housing 110 provide both portability and ergonomic benefits for the camera operator, allowing for single-handed use of the camera 100 with increased comfort and reduced effort by the camera operator when holding the camera 100. Furthermore, the particular egg-shape of the camera 100 provides for increased stability and ease of use of the camera 100 when held and operated with a single hand. While the housing 110 can be ovoid, other shapes can be suitable, such as, for example, cylindrical and rectangular, while still providing the ability to to use one hand to hold the camera, and activate the shutter button.

Note that the term “top” is used herein to identify the end 130 of the housing 110, and thus of the camera 100, that is intended to be facing upwardly when the camera 100 is held by a camera operator taking a panoramic photograph or video. Similarly, the term “bottom” is used herein to identify the end 150 of the housing 110, and thus of the camera 100, that is intended to be facing downwardly when the camera 100 is held by the camera operator taking a panoramic photograph or video. More specifically, in order to take a full 360-degree sky-to-ground photograph, the camera operator will typically hold the camera 100 in front of or above his/her body, with the top end 130 facing upwardly and the bottom end 150 facing downwardly, as will be discussed in further detail below. However, the camera 100 may be held in any orientation, with the top end 130 facing any direction, to take various different types of panoramic photographs of a surrounding scene (e.g. horizontal panoramic, vertical panoramic, etc).

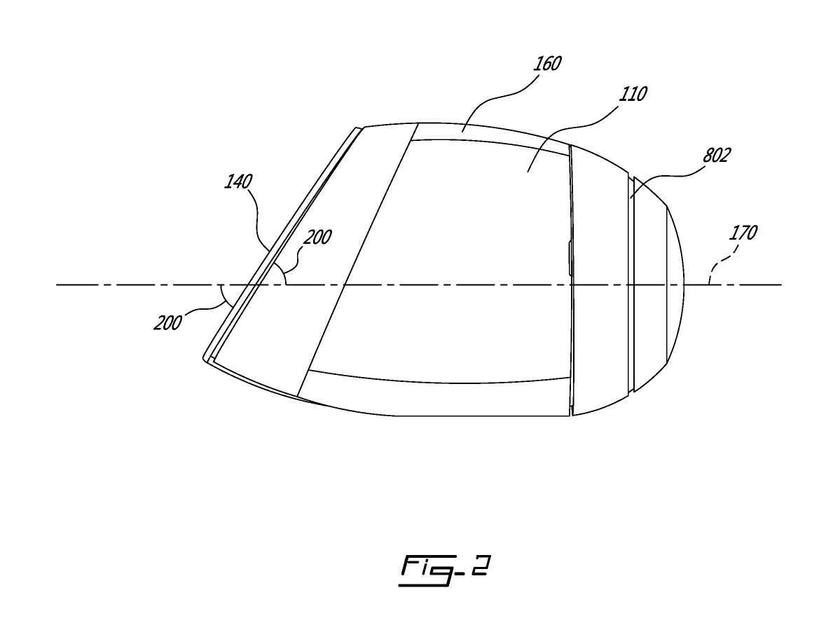

The lens 120 is an optical lens located within the housing 110 proximate the top end 130 thereof. This lens 120 may consist of a single lens or of an assembly of lenses, which lens or lens assembly may itself be formed of one or more optical lens elements. Regardless of its design and composition, the lens 120 is operative to collect light rays from a surrounding scene and focus these rays into the image sensor unit of the camera 100 where images are captured. As seen in FIGS. 1 and 2, the lens 120 is characterized by an optical axis 170 that defines the path along which light propagates through the camera 100.

The panoramic lens 120 can be a wide-angle lens, such as a fish-eye or a panomorph lens, or a plurality of (non-wide-angle) lenses or one or more mirrors for imaging a surrounding environment on one or more image sensors. The image collected may thus be a single continuous hemispherical image including a horizontal zone and an overhead dome, a single horizontal zone (omitting a vertical dome), or a plurality images able to be stitched together to form a panoramic image. A panomorph lens is a wide-angle lens that provides better resolution in the horizontal zone than in the vertical dome.

In a specific, non-limiting example of implementation, the lens 120 is an elliptical lens assembly, operative to capture light from a surrounding scene in a viewing angle of 360 degrees about the optical axis 170 (i.e. elliptical images, including but not limited to circular images). In one possible non-limiting example, as depicted in FIG. 1, the viewing angle is in fact 360 degrees by 200 degrees, since the elliptical lens assembly 120 provides a field of view that encompasses the full 180 degrees above the plane 190 of the top end 130 of the housing 110 (plane 190 being perpendicular to the optical axis 170), as well as up to 20 degrees below this plane 190. Such an elliptical lens assembly 120 maximizes a field of view from which light is captured for the image sensor unit, whereby the camera 100 is capable to capture a scene in front of, above, below and behind the camera operator. Note that the elliptical lens assembly 120 may alternatively capture a field of view with different viewing angles (e.g. less than 360 degrees about the optical axis 170 and/or more or less than 200 degrees above/below plane 190).

Continuing with the example of an elliptical lens assembly 120, when the camera operator holds the camera 100, it is the orientation of the camera 100 (i.e. direction in which the lens 120 is pointed), rotation of the camera 100 (i.e. orientation of the elliptical lens 120) and the position of the camera 100 with respect to the camera operator's body (e.g. in front of or above) that determine the type of panoramic photograph/video to be taken. For example, when the camera operator holds the camera 100 in front of his/her body with the elliptical lens 120 pointed upwardly, the camera operator can take a 360-degree sky-to-ground panoramic photograph of the scene surrounding the camera 100. In another example, when the camera operator holds the camera 100 in front of his/her body with the elliptical lens 120 pointed outwardly and in a horizontal orientation, the camera operator can take a horizontal panoramic photograph of the scene surrounding the camera 100. In another example, when the camera operator holds the camera 100 in front of his/her body with the elliptical lens 120 pointed outwardly and in a vertical orientation, the camera operator can take a vertical panoramic photograph of the scene surrounding the camera 100.

Since the optical functionality and operation of an elliptical lens assembly in the context of a panoramic camera will be apparent to those skilled in the art, they will not be discussed in further detail herein.

It is important to note that various different types of lenses and lens assemblies that are operative to instantaneously capture panoramic images, comprising various different numbers of optical lens elements, are possible for the lens 120 of the camera 100, without departing from the scope of the present invention.

As shown in FIGS. 1, 2 and 4, a display screen 140 is provided at the bottom end 150 of the housing 110. This display screen 140 displays to the camera operator the field of view that the camera 100 is positioned and orientated to capture in a photograph. The display screen 140 may also display to the camera operator a photograph or video that was previously taken by the camera 100.

In a specific, non-limiting example of implementation, the display screen 140 is elliptical or oval in shape for displaying the field of view captured by an elliptical lens 120, as seen in FIG. 4. However, various different shapes are also possible for the display screen 140.

The display screen 140 is disposed at a particular angle at the bottom end 150 of the housing 110, as seen in FIGS. 1 and 2. More specifically, the display screen 140 is angled on the housing 110 to provide visibility of the display screen 140 to the camera operator when taking a photograph or video. Thus, as shown in FIG. 5, when the camera 100 is held in front of or above the camera operator with the optical axis 170 in a vertical plane (i.e. with the top end 130 facing upwardly and the bottom end 150 facing downwardly), the angled display screen 140, and thus the displayed field of view to be captured by the camera 100, is still visible to the camera operator, which can greatly help the camera operator capture a desired photograph or video.

The display screen 140 is therefore angled on the housing 110 such that the optical axis 170 and the display screen 140 define an acute angle 200 therebetween, as shown in FIG. 2. In one example, this acute angle 200 is 45 degrees; however, various different acute angles are also possible without departing from the scope of the present invention.

In a specific, non-limiting example of implementation of the present invention, the display screen 140 is a liquid crystal display (LCD) screen with touch screen capability, whereby the camera operator can not only view images on the display screen 140 but also provide basic commands to the camera 100 via the display screen 140 by touching icons appearing on the display screen 140 (e.g. view photograph, play video, delete photograph/video, etc.). The user interface presented to the camera operator via the display screen 140 may be implemented by an internal processing unit of the camera 100.

The switch 160 on the housing 110 is a control or trigger that allows the camera operator to cause the camera 100 to take a photograph. In a specific, non-limiting example of implementation, the switch 160 is a push-button type of control that responds to pressure applied thereon by the camera operator to cause the camera 100 to take a photograph, such as in the case of a shutter-release button on standard cameras. Therefore, when the camera operator presses on the switch 160 (for example with the thumb of the hand holding the camera 100, as seen in FIG. 5), the switch 160 triggers the opening of a shutter (mechanical or electrical) covering the lens 120 of the camera 100, so that the lens 120 can capture light from the surrounding scene and focus this light onto the image sensor unit within the housing 110 of the camera 100 for generating an image, the shutter closing automatically after a predetermined exposure time determined by a pre-set shutter speed.

As seen in FIGS. 1, 2 and 5, the switch 160 may take the form of a mechanically biased plate or panel located between the top and bottom ends 130, 150 of the housing 110, where this panel 160 is characterized by a default position in which it is co-incident with an outer surface of the housing 110 and forms an integral part of the body of the housing 110 of the camera 100. Such a design is extremely ergonomic, allowing the camera operator to hold the camera 100 in one hand and easily activate the switch 160 with the same hand. However, the switch 160 may also take various different forms, shapes, sizes and positions on the housing 110, without departing from the scope of the present invention.

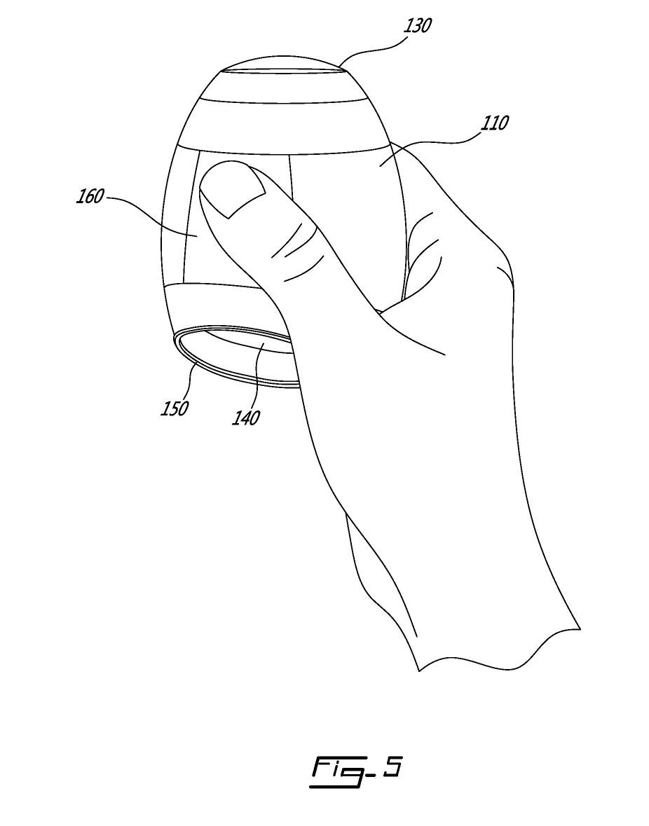

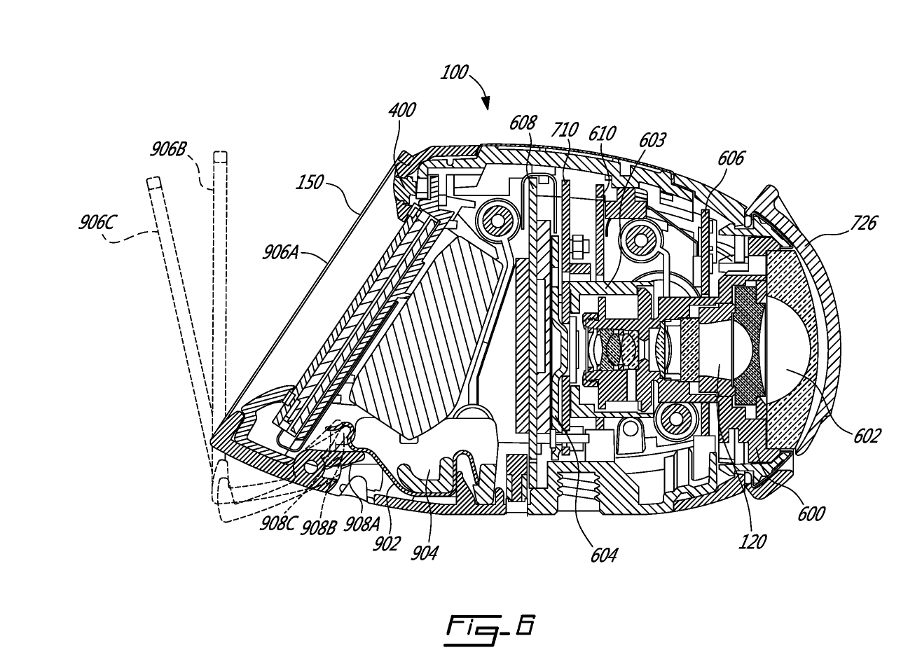

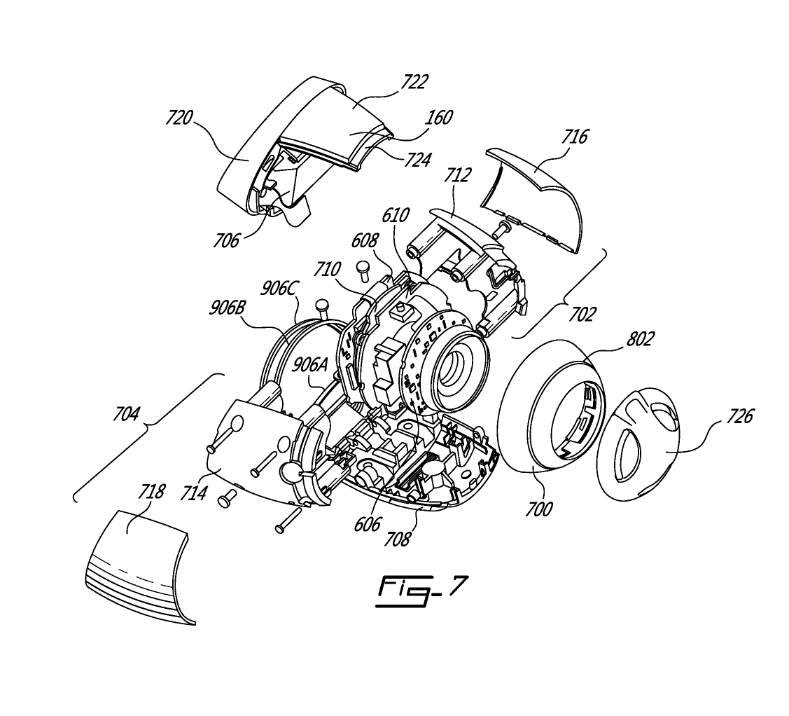

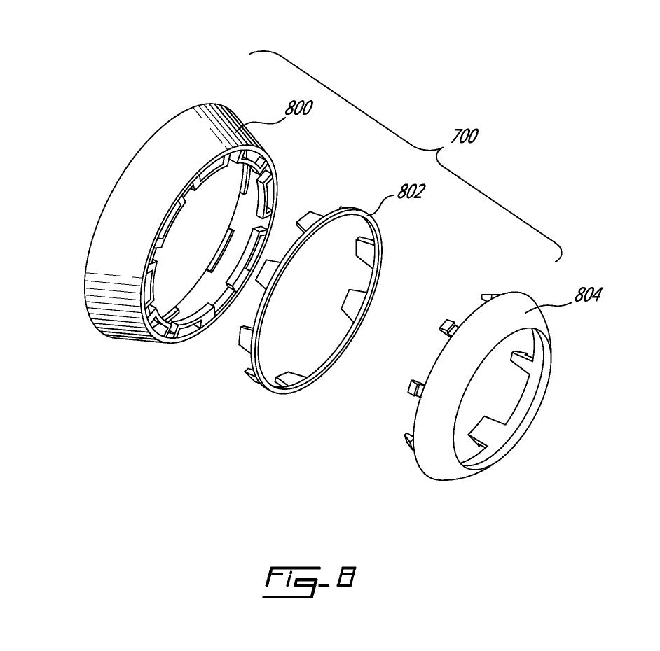

FIG. 6 illustrates a cross-sectional view of the internal components of the camera 100 taken along its optical axis 170, while FIG. 7 illustrates an exploded view of the camera 100, its housing unit 110 and internal components.

In a specific non-limiting example of implementation of the present invention, the ovoid-shaped housing 110 of the camera 100 is a multi-component assembly, as seen in FIGS. 6 and 7. With reference to FIG. 7, the housing 110 includes a top housing assembly 700, a left frame assembly 702, a right frame assembly 704, a bottom housing assembly 706 and a rear housing assembly 708. Upon construction of the camera 100, all of these assemblies are fitted together to encompass the image sensor unit 710 and other internal components of the camera 100, thereby forming the protective, ovoid-shaped external housing 110 of the camera 100.

Each separate assembly 700, 702, 704, 706, 708 of the housing 110 may itself comprise one or more elements or components which fit together and/or interconnect to form the respective assembly. These components may be formed of various different types of materials including for example metal, metal alloy, polymer, plastic, rubber and elastomer, among other possibilities. Specific to the present invention, each such component is molded or extruded during its construction to acquire a respective, predetermined shape that contributes to the final, egg-shape of the assembled housing 110. For example, the top housing assembly 700 is characterized by a tapering cone shape, while the left and right frame assemblies 702, 704 are characterized by an arc shape.

In a non-limiting example, the top housing assembly 700, which is also shown in FIG. 8, is formed of a body 800, a light pipe 802 and a bezel assembly 804, the latter operative to mechanically couple with the body 800 for holding the components of the top housing assembly 700 together. The light pipe 802 is a circular tube or pipe for transporting or distributing light over its length, as will be discussed in further detail below. Various different constructions and materials may be used for the light pipe 802 of the camera 100.

In another non-limiting example, each of the left and right frame assemblies 702, 704 includes a moulded or extruded body frame (712 and 714, respectively), as well as a cosmetic cover (716 and 718, respectively). The body frames 712, 714 are designed to fit around the image sensor unit 710 and other internal components of the camera 100 upon assembly. The cosmetic covers 716, 718 of the left and right frame assemblies 702, 704 form a part of the protective outer surface of the housing 110, adjacent to the switch 160 once the camera 100 is fully assembled.

In yet another non-limiting example, the bottom housing assembly 706 includes the display screen 140, a support frame 720 for the display screen 140 and the switch 160. In a specific, non-limiting example of implementation, the switch 160 is a switch assembly formed of a switch cover 722 and a switch support 724, this switch assembly being electrically or mechanically connected to a shutter of the lens 120 in the assembled camera 100. In the assembled camera 100, the support frame 720 and switch 160 join with the left and right frame assemblies 702, 704, as well as with the rear housing assembly 708 to form part of the external surface or body of the protective housing 110 of the camera 100. It is the support frame 720 that defines the bottom end 150 of the housing 110, and thus of the camera 100.

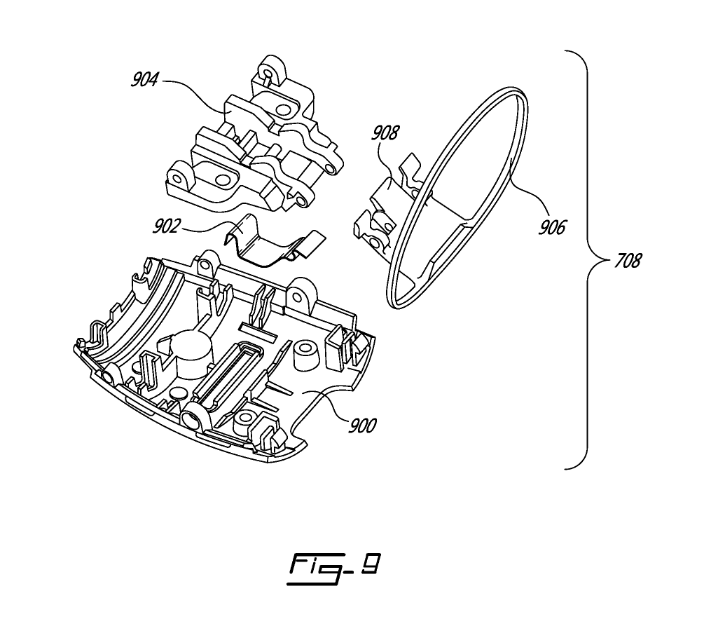

In a further non-limiting example, the rear housing assembly 708, which is also shown in FIG. 9, includes a rear frame 900, a spring 902, a wrist strap support 904 and a ring 906. In the assembled camera 100, the ring 906 is mechanically coupled to the wrist strap support 904 and to the spring 902, whereby the ring 906 is rotatable about an axis of attachment to the wrist strap support 904, as will be discussed further below. The wrist strap support 904 provides a hitch to which a wrist strap can be attached, such that the camera operator can use the wrist strap to carry or secure the panoramic camera 100. The rear frame 900 and the ring 906 join with the left and right frame assemblies 702, 704, as well as with the bottom housing assembly 706, in the assembled camera 100 to form part of the external surface of the protective housing 110 of the camera 100.

Note that, in variant embodiments of the present invention, the housing 110 of the panoramic camera 100 may include more or less housing assemblies than described above, without departing from the scope of the present invention. Furthermore, each separate housing assembly may include more, less and/or different components than those described above. However, any such components and/or housing assemblies will be sized and shaped such that, when assembled together, they impart an ovoid or egg shape to the protective housing 110 of the camera 100.

Various different types of attachment mechanisms may be used to interconnect and hold together the various assemblies 700, 702, 704, 706, 708 of the housing 110 upon construction of the camera 100, as well as to interconnect and hold together the various components of each assembly. Such attachment mechanisms may include screws (as shown in FIG. 7), nuts and bolts, welding, hooks, apertures and pins, groove and flange connections, springs, friction force and adhesive, among many other possibilities.

In a variant embodiment of the present invention, the housing 110 of the camera 100 optionally includes a detachable, protective cover 726 for securing to the top end 130 of the housing 110 when the camera 100 is not in use and/or is being transported, as shown in FIGS. 6 and 7. In one example, this cover 726 is made of any suitable, material, such as plastic or rubber, and is designed in a circular shape to fit over the top end 130 of the egg-shaped housing 110. The cover 726 has protruding ridges that engage grooves in the top housing assembly 700 for detachably coupling or securing the cover 726 to the housing 110. Note however that different sizes and shapes are possible for the cover 725, as are different attachment mechanisms for securing the cover 726 to the camera 100.

With reference to FIG. 6, the image sensor unit 710 and lens assembly 120 are but two of various different possible internal components of the camera 100, all contained within the egg-shaped housing 110. Each such internal component provides a different functionality to the operation of the panoramic camera 100.

As is well known to those skilled in the art, the image sensor unit 710 of the camera 100 is operative to capture light and to convert an optical image into an electronic signal. Different types of sensors (e.g. CCD image sensor, CMOS imaging chip, etc.) are possible for the image sensor unit 710, as are different types of processing and image generation operations, without departing from the scope of the present invention. In a specific, non-limiting example of implementation, the image sensor unit 710 is operative to capture an elliptical panoramic image, and to process this captured light energy for generating digital information allowing to display the panoramic image in a viewer or viewing window, such as display screen 140 or a display of a remote computing device.

In a specific, non-limiting example of implementation, the image sensor unit 710 includes one or more integrated circuits, each packaged as a printed circuit board (PCB) or as an application-specific integrated circuit (ASIC) logic die stacked on a laminate substrate. In one example, the image sensor unit 710 is formed of an integrated circuit package on package (PoP) (i.e. two or more logic and/or memory packages stacked or installed atop one another with a standard interface to route signals therebetween), allowing for a higher component density within the relatively small, egg-shaped internal space of the housing 110 of the panoramic camera 100.

The image sensor unit 710 and lens assembly 120 together form part of an imager assembly of the camera 100, which may include various other elements, including for example a lens shutter, a frame 600 for the lens assembly 106, a transparent cover 602 to protect the lens assembly 120 (at the top end 130 of the housing 110 in the assembled camera 100) and a base 603.

Examples of other possible internal components of the camera 100 may include a heat sink plate 604 for dissipating at least in part the heat generated by the image sensor unit 710 during its processing operations, a light-emitting diode (LED) PCB or PoP 606, a microphone and speaker (not shown), a radio-frequency identification (RFID) antenna (not shown), a central processing unit (CPU) PCB or PoP 608 and a Wi-Fi PCB or PoP 610, among many other possibilities.

The various internal components and modules of the camera 100 may all be implemented in software, hardware, firmware or any combination thereof. Obviously, various different software, hardware and/or firmware based implementations of these components and modules are possible and included within the scope of the present invention.

In a broad embodiment of the present invention, the panoramic camera 100 includes a visual indicator on the housing 110 for guiding the camera operator during the taking of a photograph or video. More specifically, the visual indicator may confirm to the camera operator when a photograph has been taken by the camera 100 or when the camera 100 begins and ends the recording of a video. This visual indicator is controlled by an internal component of the camera 100, such as the image sensor unit or a processing unit.

In a specific, non-limiting example of implementation, the visual indicator is a light on the external surface of the housing 110, positioned to be visible to the camera operator when holding the camera 100 to take a photograph or video. This light may acquire any one of an on, off and flashing state to provide visual cues to the operator as to the status of an operation performed by camera 100. For example, the light may flash once or multiple times after the camera 100 has taken a photograph, to confirm that the photography operation is completed. In another example, the light may acquire the on state when the camera 100 is recording a video, remaining in the on state until the recording has ended, at which point the light acquires the off state.

In the case of the non-limiting example of FIGS. 6 and 7, the visual indicator is a LED light ring (or tube or pipe) 802 disposed on the housing 110 near the top end 130 of the housing 110, as shown in FIG. 8 (and also seen in FIGS. 2, 3 and 7). This light pipe 802 is connected to a LED PoP 606 component of the camera 100, which generates the light that is distributed over the length (circumference) of the light pipe 802. Operation of the LED PoP 606 component, and thus lighting of the light pipe 802, may be controlled by the image sensor unit 710 or alternatively by the CPU PoP 608 of the camera 100.

In another broad embodiment of the present invention, the panoramic camera 100 includes a stand at the bottom end 150 of the housing 110, operative to support the camera 100 on a horizontal surface for maintaining the camera 100 in a position in which its top end 130 is upwardly facing and its optical axis 170 is in a vertical plane. In other words, the stand positions the camera 100 to take a full 360-degree sky-to-ground panoramic photograph (or video) and holds the camera 100 in this position without assistance from an operator of the camera.

In a specific, non-limiting example of implementation, the stand is movable between a closed position in which the stand is substantially flush with the bottom end 150 of the housing 110, and an open position in which the stand is capable to support the camera 100 on a horizontal surface. Thus, when a camera operator wants to set the camera 100 down on a horizontal surface with the top end 130 of the camera 100 facing upwardly, the camera operator moves the stand to its open position and set the camera 100 down on its stand.

In the case of the non-limiting example of FIGS. 6 and 7, the stand is the substantially circular ring 906 of the rear housing assembly 708, as shown in FIG. 9 (and also seen in FIGS. 1, 6 and 7). In FIG. 1, the ring 906 is shown in the open position, supporting the camera 100 on a horizontal surface. In FIGS. 6 and 7, the ring 906 is shown in multiple different positions, since the ring 906 is rotatable about an axis of attachment of the ring 906 to the wrist strap support 904 of the rear housing assembly 708. Thus, the ring 906 is rotatable between a closed position (906A) in which the ring 906 is substantially flush with the bottom end 150 of the housing 110 and an open position (906B) in which the ring 906 can support the camera 100 on a horizontal surface. As shown in FIGS. 6 and 9, the ring 906 has a projection 908 that interacts with a respective channel in the spring 902 of the rear housing assembly 708, for maintaining the ring 906 in each of the open and closed positions.

In a variant embodiment of the present invention, the stand is also operative to control an automatic timer of the camera 100, where this timer may be implemented by the image sensor unit 710 or a processing unit of the camera 100. Thus, the stand is movable by the camera operator to one or more trigger positions for starting an internal timer of the camera 100, which timer will cause the camera 100 to automatically take a photograph upon expiry of a predetermined period of time associated with the respective trigger position, without need for the camera operator to activate the switch 160.

In the case of the non-limiting example of FIGS. 6 and 7, the ring 906 of the rear housing assembly 708 acts as the stand and is further operative to control an internal timer of the camera 100. More specifically, the ring 906 is rotatable to at least one trigger position (906C) for triggering an internal timer of the camera 100. As discussed above, the projection 908 of the ring 906 interacts with the spring 902 upon rotation of the ring 906. Thus, movement of the ring 906 to trigger position 906C causes projection 908 to apply pressure to an end of the spring 902, which initiates one or more internal component movements and/or signal transmissions within the housing 110 for triggering the internal timer of the camera 100. Since the spring 902 is biased to return to its default position (before deformation by the pressure applied by projection 908), the spring 902 will force the ring 906 to rotate back to the open position 906B, rather than remain in the trigger position 906C.

Note that the stand of the camera 100 (e.g. ring 906) may be movable to more than one trigger position, each such trigger position being associated with a respective period of time to which the internal timer will be set for automatically taking a photograph. In one non-limiting example, the stand is movable to two different trigger positions, the first of which causes the internal timer to be set to 25 seconds, the second of which causes the internal timer to be set to 45 seconds. In the case of either trigger position, the stand is biased back from the respective trigger position to the open position, such that once the timer has been set, the camera 100 can be set down on its stand on a horizontal surface and left unattended by the camera operator.

In yet another variant embodiment of the present invention, the camera 100 includes an input/output port for exchanging data and communications with an external computing device, where this input/output port may be controlled by a processing unit of the camera 100. In a specific, non-limiting example of implementation, this input/output port is a USB port 400 built into the support frame 720 of the bottom housing assembly 706 of the housing unit 110, as shown in FIGS. 4 and 6. This USB port 400 is connected to the CPU PoP 608 of the camera 100. Thus, the camera 100 is connectable via its USB port 400 to a computer or a computer peripheral, for transferring photographs and videos taken by the camera 100 to the computer, a storage device or other peripheral device.

In a further variant embodiment of the present invention, the camera 100 is operative to wirelessly connect with a remote or external computing device, such as a personal computer, a smart phone or a tablet, for exchanging data and/or communications with the remote computing device. For example, photographs and videos may be wirelessly transferred from the camera 100 to the remote computing device. In another example, control signals may be received by the camera 100 from the remote computing device, such as a remote control signal causing the camera 100 to automatically take a photograph. In a specific, non-limiting example of implementation, this wireless connectivity of the camera 100 is provided by Wi-Fi PoP 610, as shown in FIGS. 6 and 7.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

1. A panoramic camera comprising:
a. a housing having a top end and a bottom end;
b. a panoramic lens disposed proximate to said top end of said housing;
c. a display screen disposed at said bottom end of said housing;
d. an image sensor unit within said housing, said image sensor unit operative to capture images;
e. a switch on said housing, said switch activatable by a camera operator for causing said camera to take a photograph or video.

2. A panoramic camera as defined in claim 1, wherein said lens is elliptical for capturing light from a surrounding scene in a viewing angle of 360 degrees about an optical axis of said lens.

3. A panoramic camera as defined in claim 1, wherein said camera is adapted to be held in one hand by the camera operator when taking a photograph or video, said switch activatable with the same hand.

4. A panoramic camera as defined in claim 1, wherein said switch is located between said top and bottom ends of said housing, said switch forming a portion of a body of said housing.

5. A panoramic camera as defined in claim 1, wherein said display screen is angled on said housing to provide visibility of said display screen when said camera is held in front or above of the camera operator with said optical axis in a vertical plane.

6. A panoramic camera as defined in claim 5, wherein said display screen and said optical axis define an acute angle therebetween.

7. A panoramic camera as defined in claim 5, wherein said display screen and said optical axis define a 45-degree angle therebetween.

8. A panoramic camera as defined in claim 1, wherein said display screen is a liquid crystal display (LCD) screen.

9. A panoramic camera as defined in claim 1, wherein said display screen is touch sensitive.

10. A panoramic camera as defined in claim 1, further comprising a visual indicator on said housing for guiding the camera operator during the taking of a photograph or video.

11. A panoramic camera as defined in claim 10, wherein said visual indicator is a light that acquires one of an on, off and flashing state to provide visual cues to the camera operator.

12. A panoramic camera as defined in claim 10, wherein said visual indicator includes a circumferential light guide disposed on said housing proximate said top end of said housing.

13. A panoramic camera as defined in claim 1, further comprising a stand at said bottom end of said housing, said stand operative to support said camera on a horizontal surface such that said optical axis is in a vertical plane.

14. A panoramic camera as defined in claim 13, wherein said stand is movable between a closed position and an open position, in said open position said stand capable to support said camera on a horizontal surface.

15. A panoramic camera as defined in claim 14, wherein in said closed position said stand is substantially flush with said bottom end of said housing.

16. A panoramic camera as defined in claim 15, wherein said stand is a substantially circular ring that is rotatable between said open and closed positions about an axis of attachment of said ring to said housing.

17. A panoramic camera as defined in claim 13, wherein said stand is further operative to control an automatic timer of said camera.

18. A panoramic camera as defined in claim 17, wherein said stand is movable to at least one trigger position for starting said timer to cause said camera to automatically take a photograph upon expiry of a predetermined period of time associated with said trigger position.

19. A panoramic camera as defined in claim 1, wherein said housing has an outer ovoid shape.

20. A panoramic camera comprising:
a. a housing having a top end and a bottom end;
b. a panoramic lens disposed proximate to said top end of said housing;
c. a display screen disposed at said bottom end of said housing;
d. an image sensor unit within said housing, said image sensor unit operative to capture images;
e. a switch on said housing, said switch activatable by a camera operator for causing said camera to take a photograph or video;
f. a stand at said bottom end of said housing, said stand movable between a closed position and an open position.

21. A panoramic camera comprising:
a. a housing having a top end and a bottom end;
b. a panoramic lens disposed proximate to said top end of said housing;
c. a display screen disposed at said bottom end of said housing;
d. an image sensor unit within said housing, said image sensor unit operative to capture images;
e. a switch on said housing, said switch activatable by a camera operator for causing said camera to take a photograph or video;
f. a visual indicator on said housing for guiding the camera operator during the taking of a photograph or video.
